(19) United States
(12) Patent Application Publication
(10) Pub. No.: US 2009/0198956 A1
(43) Pub. Date: Aug. 6, 2009

(54) System and Method for Data Processing Using a Low-Cost Two-Tier Full-Graph Interconnect Architecture

(76) Inventors: Lakshminarayana B. Arimilli, Austin, TX (US); Ravi K. Arimilli, Austin, TX (US); Ramakrishnan Rajamony, Austin, TX (US); Edward J. Seminaro, Milton, NY (US); William E. Speight, Austin, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(21) Appl. No.: 12/024,662

(22) Filed: Feb. 1, 2008

(51) Int. Cl. G06F 15/80; G06F 15/76; G06F 9/00

(52) U.S. Cl. 712/13; 712/29; 712/E09.001

(57) ABSTRACT

A system and method are provided for implementing a two-tier full-graph interconnect architecture. In order to implement a two-tier full-graph interconnect architecture, a plurality of processors are coupled to one another to create a plurality of supernodes. Then, the plurality of supernodes are coupled together to create the two-tier full-graph interconnect architecture. Data is then transmitted from one processor to another within the two-tier full-graph interconnect architecture based on an addressing scheme that specifies at least a supernode and a processor chip identifier associated with a target processor to which the data is to be transmitted.

### GOVERNMENT RIGHTS

This invention was made with United States Government support under Agreement No. HR0011-07-9-0002 awarded by DARPA. THE GOVERNMENT HAS CERTAIN RIGHTS IN THE INVENTION.

### BACKGROUND

1. Technical Field

The present application relates generally to an improved data processing system, apparatus, and method. More specifically, the present application is directed to a low-cost two-tier full-graph interconnect architecture for data processing.

2. Description of Related Art

Ongoing advances in distributed multi-processor computer systems have continued to drive improvements in the various technologies used to interconnect processors, as well as their peripheral components. As the speed of processors has increased, the underlying interconnect, intervening logic, and the overhead associated with transferring data to and from the processors have all become increasingly significant factors impacting performance. Performance improvements have been achieved through the use of faster networking technologies (e.g., Gigabit Ethernet), network switch fabrics (e.g., Infiniband and RapidIO®), TCP offload engines, and zero-copy data transfer techniques (e.g., remote direct memory access). Efforts have also been increasingly focused on improving the speed of host-to-host communications within multi-host systems. Such improvements have been achieved in part through the use of high-speed network and network switch fabric technologies.

### SUMMARY

The illustrative embodiments provide an architecture and mechanisms for facilitating communication between processors or nodes, collections of nodes, and supernodes. The illustrative embodiments provide a highly-configurable, scalable system that integrates computing, storage, networking, and software. The illustrative embodiments provide for a low-cost two-tier full-graph interconnect architecture that improves communication performance for parallel or distributed programs and improves the productivity of the programmer and system. The architecture is comprised of a plurality of processors or nodes that are associated with one another as a collection referred to as “supernodes”.

In the illustrative embodiments, a plurality of processors are coupled to one another to create a plurality of supernodes. In the illustrative embodiments, the plurality of supernodes are coupled together. In the illustrative embodiments, data is transmitted from one processor to another based on an addressing scheme specifying at least a supernode identifier and a processor chip identifier associated with a target processor to which the data is to be transmitted.

In the illustrative embodiments, a subset of processors of the plurality of processors may be associated with each supernode of the plurality of supernodes. In the illustrative embodiments, each processor within the supernode may be directly coupled to each other processor within the supernode. In the illustrative embodiments, each supernode within a subset of the plurality of supernodes may be directly coupled to each other supernode within the subset of the plurality of supernodes. In the illustrative embodiments, the subset of processors may comprise at least eight processors. In the illustrative embodiments, the subset of the plurality of supernodes may comprise at least five hundred and twelve supernodes.

In the illustrative embodiments, the subset of processors may be coupled to each other by a set of first buses. In the illustrative embodiments, the subset of supernodes may be coupled to each other by a set of second buses. In the illustrative embodiments, data may be routed from one processor in a first supernode to another processor in a second supernode using at least one routing table data structure that specifies at least one first bus and at least one second bus over which the data is to be transmitted.

In the illustrative embodiments, at least one of the set of first buses and the set of second buses may be cache coherent buses. In the illustrative embodiments, at least one of the set of first buses and the set of second buses may be non-cache coherent buses. In the illustrative embodiments, the set of first buses may be cache coherent and the set of second buses may be non-cache-coherent buses.

In the illustrative embodiments, each processor in the plurality of processors of a supernode may comprise at least four communication links for coupling the processor to at least four other supernodes in the plurality of supernodes. In the illustrative embodiments, each supernode of the plurality of supernodes may comprise at least five hundred and eleven communication links for coupling the supernode to at least five hundred and eleven other supernodes in the plurality of supernodes.

In the illustrative embodiments, each processor of the plurality of processors may have an integrated switch. In the illustrative embodiments, the integrated switch in the processor may implement the addressing scheme to route data from that processor to at least one other processor in the plurality of processors. In the illustrative embodiments, the integrated switch in each processor of the plurality of processors may utilize one or more routing table data structures that specify pathways from the processor to other processors in the data processing system based on the supernode identifier and the processor chip identifier.

In the illustrative embodiments, each processor in the supernode may be directly coupled to four other processors within different supernodes, the four other processors each being in separate other supernodes. In the illustrative embodiments, each processor may have a plurality of cores. In the illustrative embodiments, the plurality of cores may be homogeneous. In the illustrative embodiments, the plurality of cores may be heterogeneous. In the illustrative embodiments, the data processing system may utilize a low-cost two-tier full-graph interconnect architecture.

In yet another illustrative embodiment, a system is provided. The system may comprise a processor and a memory coupled to the processor. The memory may comprise instructions which, when executed by the processor, cause the processor to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary representation of an exemplary distributed data processing system in which aspects of the illustrative embodiments may be implemented;

FIG. 2 is a block diagram of an exemplary data processing system in which aspects of the illustrative embodiments may be implemented;

FIG. 3 depicts an exemplary logical view of a processor chip, which may be a “node” in the two-tier full-graph interconnect architecture, in accordance with one illustrative embodiment;

FIGS. 4A and 4B depict an example of such a two-tier full-graph interconnect architecture in accordance with one illustrative embodiment;

FIG. 5 depicts an example of direct and indirect transmissions of information using a two-tier full-graph interconnect architecture in accordance with one illustrative embodiment;

FIG. 6 depicts a flow diagram of the operation performed in the direct and indirect transmissions of information using a two-tier full-graph interconnect architecture in accordance with one illustrative embodiment;

FIG. 7 depicts an exemplary method of integrated switch/routers (ISRs) utilizing routing information to route data through a two-tier full-graph interconnect architecture network in accordance with one illustrative embodiment;

FIG. 8 is a flowchart outlining an exemplary operation for selecting a route based on whether or not the data has been previously routed through an indirect route to the current processor in accordance with one illustrative embodiment; and

FIG. 9 depicts a flow diagram of the operation performed to route data through a two-tier full-graph interconnect architecture network in accordance with one illustrative embodiment.

### DETAILED DESCRIPTION OF THE ILLUSTRATIVE EMBODIMENTS

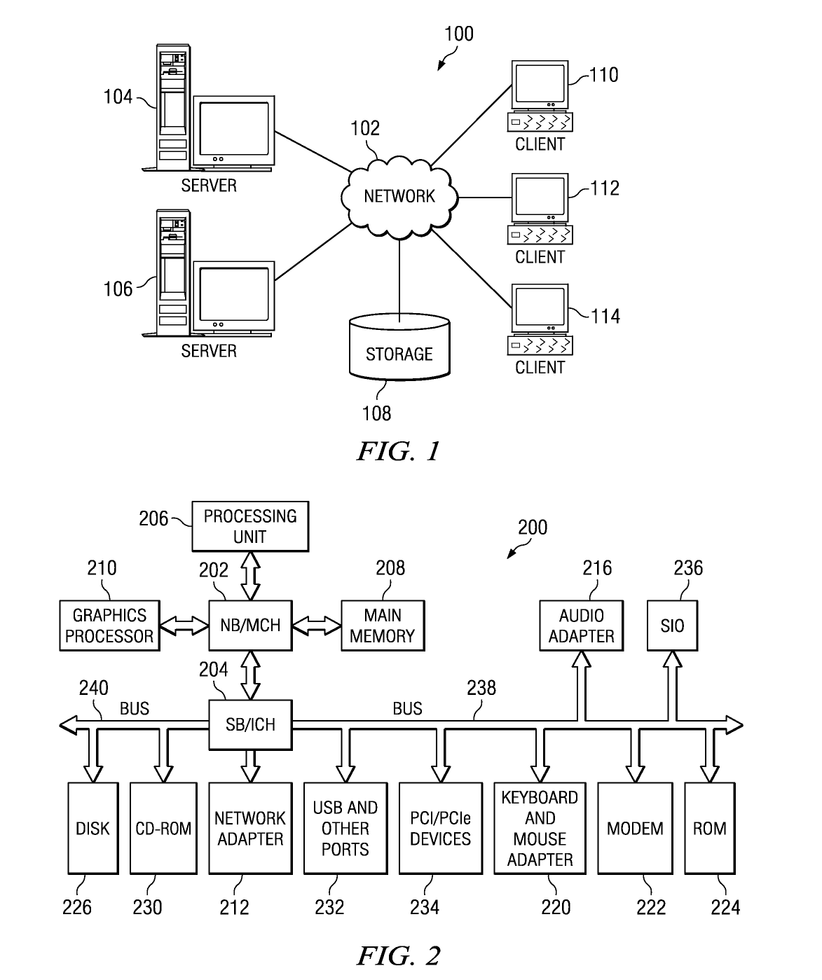

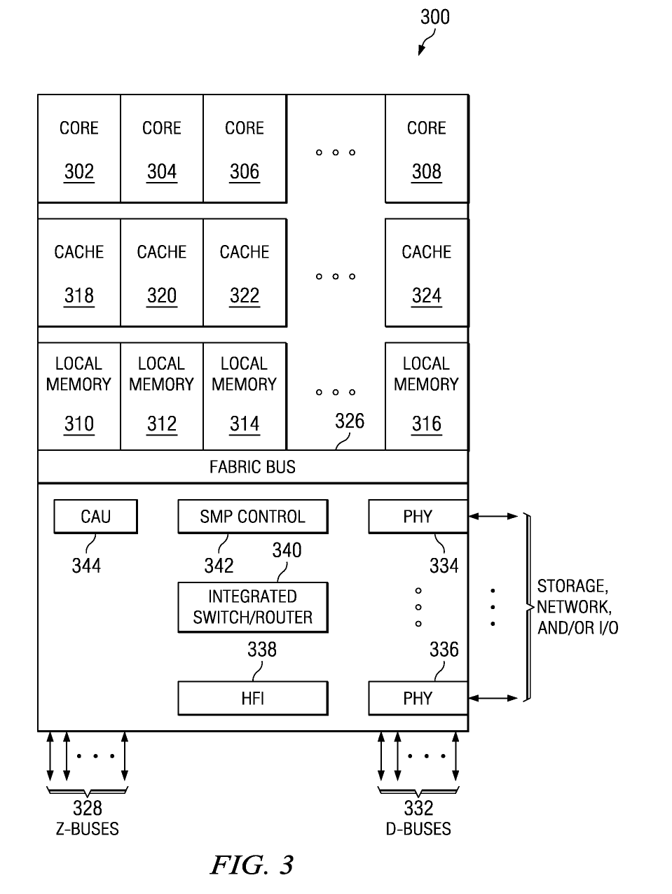

The illustrative embodiments provide an architecture and mechanisms for facilitating communication between processors or nodes, collections of nodes, and supernodes. As such, the mechanisms of the illustrative embodiments are especially well suited for implementation within a distributed data processing environment and within, or in association with, data processing devices, such as servers, client devices, and the like. In order to provide a context for the description of the mechanisms of the illustrative embodiments, FIGS. 1-2 are provided hereafter as examples of a distributed data processing system, or environment, and a data processing device, in which, or with which, the mechanisms of the illustrative embodiments may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p™ computer system, running the Advanced Interactive Executive (AIX®) operating system or the LINUX® operating system (eServer, System p™ and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors, such as the POWER™ processor available from International Business Machines Corporation of Armonk, N.Y., in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

The illustrative embodiments provide a highly-configurable, scalable system that integrates computing, storage, networking, and software. The illustrative embodiments provide for a two-tier full-graph interconnect architecture that improves communication performance for parallel or distributed programs and improves the productivity of the programmer and system. The architecture is comprised of a plurality of processors or nodes that are associated with one another as a collection referred to as a “supernode.” A “supernode” may be defined as a collection of processor chips having local connections for direct communication between the processors. A “supernode” may further contain physical memory cards, one or more I/O hub cards, and the like. The “supernodes” are in turn in communication with one another via external communication links. With such an architecture, and the additional mechanisms of the illustrative embodiments described hereafter, a two-tier full-graph interconnect is provided in which maximum bandwidth is provided to each of the processors or nodes, such that enhanced performance of parallel or distributed programs is achieved.

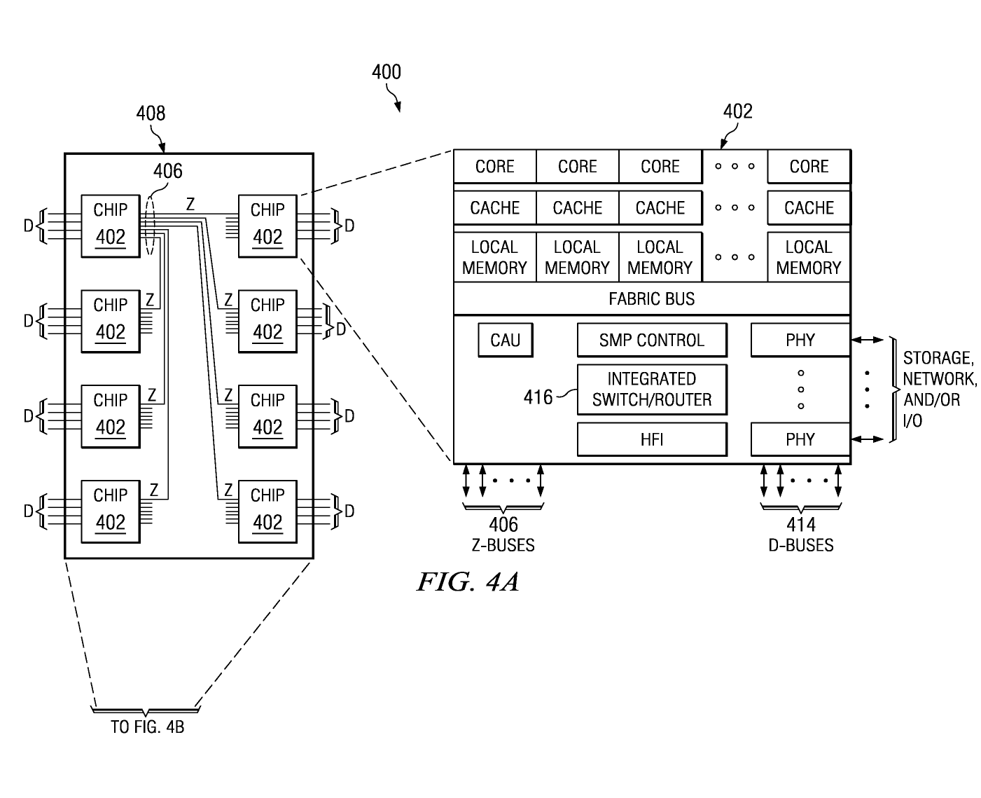

FIG. 3 depicts an exemplary logical view of a processor chip, which may be a “node” in the two-tier full-graph interconnect architecture, in accordance with one illustrative embodiment. Processor chip 300 may be a processor chip such as processing unit 206 of FIG. 2. Processor chip 300 may be logically separated into the following functional components: homogeneous processor cores 302, 304, 306, and 308, and local memory 310, 312, 314, and 316. Although processor cores 302, 304, 306, and 308 and local memory 310, 312, 314, and 316 are shown by example, any type and number of processor cores and local memory may be supported in processor chip 300.

Processor chip 300 may be a system-on-a-chip such that each of the elements depicted in FIG. 3 may be provided on a single microprocessor chip. Moreover, in an alternative embodiment processor chip 300 may be a heterogeneous processing environment in which each of processor cores 302, 304, 306, and 308 may execute different instructions from each of the other processor cores in the system. Moreover, the instruction set for processor cores 302, 304, 306, and 308 may be different from other processor cores, for example, one processor core may execute Reduced Instruction Set Computer (RISC) based instructions while other processor cores execute vectorized instructions. Each of processor cores 302, 304, 306, and 308 in processor chip 300 may also include an associated one of cache 318, 320, 322, or 324 for core storage.

Processor chip 300 may also include an integrated interconnect system indicated as Z-buses 328 and D-buses 332. Z-buses 328 and D-buses 332 provide interconnection to other processor chips in a two-tier complete graph structure, which will be described in detail below. The integrated switching and routing provided by interconnecting processor chips using Z-buses 328 and D-buses 332 allow for network communications to devices using communication protocols, such as a message passing interface (MPI) or an internet protocol (IP), or using communication paradigms, such as global shared memory, to devices, such as storage, and the like.

Additionally, processor chip 300 implements fabric bus 326 and other I/O structures to facilitate on-chip and external data flow. Fabric bus 326 serves as the primary on-chip bus for processor cores 302, 304, 306, and 308. In addition, fabric bus 326 interfaces to other on-chip interface controllers that are dedicated to off-chip accesses. The on-chip interface controllers may be physical interface macros (PHYs) 334 and 336 that support multiple high-bandwidth interfaces, such as PCIx, Ethernet, memory, storage, and the like. Although PHYs 334 and 336 are shown by example, any type and number of PHYs may be supported in processor chip 300. The specific interface provided by PHY 334 or 336 is selectable, where the other interfaces provided by PHY 334 or 336 are disabled once the specific interface is selected.

Processor chip 300 may also include host fabric interface (HFI) 338 and integrated switch/router (ISR) 340. HFI 338 and ISR 340 comprise a high-performance communication subsystem for an interconnect network, such as network 102 of FIG. 1. Integrating HFI 338 and ISR 340 into processor chip 300 may significantly reduce communication latency and improve performance of parallel applications by drastically reducing adapter overhead. Alternatively, due to various chip integration considerations (such as space and area constraints), HFI 338 and ISR 340 may be located on a separate chip that is connected to the processor chip. HFI 338 and ISR 340 may also be shared by multiple processor chips, permitting a lower cost implementation. Processor chip 300 may also include symmetric multiprocessing (SMP) control 342 and collective acceleration unit (CAU) 344. Alternatively, these SMP control 342 and CAU 344 may also be located on a separate chip that is connected to processor chip 300. SMP control 342 may provide fast performance by making multiple cores available to complete individual processes simultaneously, also known as multiprocessing. Unlike asymmetrical processing, SMP control 342 may assign any idle processor core 302, 304, 306, or 308 to any task and add additional ones of processor core 302, 304, 306, or 308 to improve performance and handle increased loads. CAU 344 controls the implementation of collective operations (collectives), which may encompass a wide range of possible algorithms, topologies, methods, and the like.

HFI 338 acts as the gateway to the interconnect network. In particular, processor core 302, 304, 306, or 308 may access HFI 338 over fabric bus 326 and request HFI 338 to send messages over the interconnect network. HFI 338 composes the message into packets that may be sent over the interconnect network, by adding routing header and other information to the packets. ISR 340 acts as a router in the interconnect network. ISR 340 performs three functions: ISR 340 accepts network packets from HFI 338 that are bound to other destinations, ISR 340 provides HFI 338 with network packets that are bound to be processed by one of processor cores 302, 304, 306, and 308, and ISR 340 routes packets from any of Z-buses 328 or D-buses 332 to any of Z-buses 328 or D-buses 332. CAU 344 improves the system performance and the performance of collective operations by carrying out collective operations within the interconnect network, as collective communication packets are sent through the interconnect network. More details on each of these units will be provided further along in this application.

By directly connecting HFI 338 to fabric bus 326, by performing routing operations in an integrated manner through ISR 340, and by accelerating collective operations through CAU 344, processor chip 300 eliminates much of the interconnect protocol overheads and provides applications with improved efficiency, bandwidth, and latency.

It should be appreciated that processor chip 300 shown in FIG. 3 is only exemplary of a processor chip which may be used with the architecture and mechanisms of the illustrative embodiments. Those of ordinary skill in the art are well aware that there are a plethora of different processor chip designs currently available, all of which cannot be detailed herein. Suffice it to say that the mechanisms of the illustrative embodiments are not limited to any one type of processor chip design or arrangement and the illustrative embodiments may be used with any processor chip currently available or which may be developed in the future. FIG. 3 is not intended to be limiting of the scope of the illustrative embodiments but is only provided as exemplary of one type of processor chip that may be used with the mechanisms of the illustrative embodiments.

As mentioned above, in accordance with the illustrative embodiments, processor chips, such as processor chip 300 in FIG. 3, may be arranged into “supernodes.” Thus, the basic building block of the architecture of the illustrative embodiments is the processor chip, or node. This basic building block is then arranged using various local and external communication connections into collections of supernodes. A fully connected group of processor chips is called a supernode. In a supernode, there exists a direct communication connection between a processor chip to every other processor chip. Thereafter, yet another different set of direct communication connections between processor chips enables communication to processor chips in other supernodes. The collection of processor chips, supernodes, and their various communication connections or links gives rise to the two-tier full-graph interconnect architecture of the illustrative embodiments.

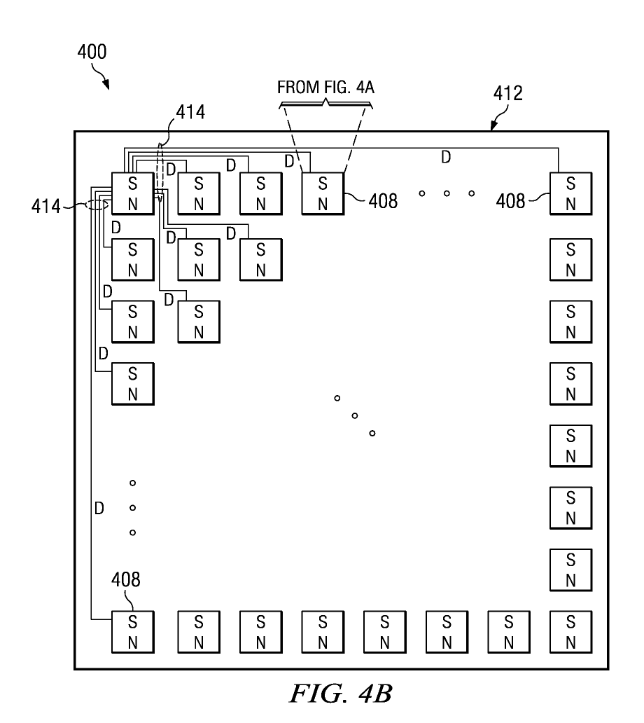

FIGS. 4A and 4B depict an example of such a two-tier full-graph interconnect architecture in accordance with one illustrative embodiment. In a data communication topology 400, processor chips 402, which again may each be a processor chip 300 of FIG. 3, for example, is the main building block. In this example, a plurality of processor chips 402 may be used and provided with local direct communication links to create supernode (SN) 408. In the depicted example, eight processor chips 402 are combined into SN 408, although this is only exemplary and other numbers of processor chips, including only one processor chip, may be used to designate a supernode without departing from the spirit and scope of the present invention. In the context of the present invention, a “direct” communication connection or link means that the particular element, e.g., a processor chip, may communicate data with another element after passing through the shortest possible number of intermediate elements. Thus, an “indirect” communication connection or link means that the data is passed through at least one more intermediary element than is required on the shortest path before reaching a destination element.

In SN 408, each of the eight processor chips 402 may be directly connected to the other seven processor chips 402 via a bus, herein referred to as “Z-buses” 406 for identification purposes. FIG. 4A indicates unidirectional Z-buses 406 connecting from only one of processor chips 402 for simplicity. However, it should be appreciated that Z-buses 406 may be bidirectional and that each of processor chips 402 may have Z-buses 406 connecting them to each of the other processor chips 402 within the same supernode. Each of Z-buses 406 may operate in a base mode where the bus operates as a network interface bus, or as a cache coherent symmetric multiprocessing (SMP) bus enabling SN 408 to operate as a 64-way (8 chips/SN×8-way/chip) SMP node. The terms “8-way,” “64-way”, and the like, refer to the number of communication pathways a particular element has with other elements. Thus, an 8-way processor chip has 7 communication connections to (and potentially from) other processor chips. A 64-way supernode has 8 processor chips that each have 7 communication connections and thus, there are 8×7 communication pathways. It should be appreciated that this is only exemplary and that other modes of operation for Z-buses 406 may be used without departing from the spirit and scope of the present invention. For example, some of Z-buses 406 may operate as a cache coherent SMP bus and others as network interface buses, enabling SN 408 to operate as two 32-way SMP nodes.

In the depicted example, a plurality of SNs 408 may be used to create two-tier full-graph (TTFG) interconnect architecture network 412. In the depicted example, 512 SNs are connected via external communication connections (the term “external” referring to communication connections that are not within a collection of elements but between collections of elements) to generate TTFG interconnect architecture network 412. While 512 SNs are depicted, it should be appreciated that other numbers of SNs may be provided with communication connections between each other to generate a TTFG interconnect architecture without departing from the spirit and scope of the present invention.

In TTFG interconnect architecture network 412, each of the 512 SNs 408 may be directly connected to the other 511 SNs 408 via buses, referred to herein as “D-buses” 414 for identification purposes. FIG. 4B indicates unidirectional D-buses 414 connecting from only one of SNs 408 for simplicity. However, it should be appreciated that D-buses 414 may be bidirectional and that each of SNs 408 may have D-buses 414 connecting them to each of the other SNs 408 within the same TTFG interconnect architecture network 412. D-buses 414 may be configured such that they are not cache coherent.

Again, while the depicted example uses eight processor chips 402 per SN 408, and 512 SNs 408 per TTFG interconnect architecture network 412, the illustrative embodiments recognize that a supernode may contain other numbers of processor chips, and a TTFG interconnect architecture network may contain other numbers of supernodes. Furthermore, while the depicted example considers only Z-buses 406 as being cache coherent, the illustrative embodiments recognize that D-buses 414 may also be cache coherent without departing from the spirit and scope of the present invention. Furthermore, Z-buses 406 may also be non cache-coherent. Yet again, while the depicted example shows a two-tier full-graph interconnect, the illustrative embodiments recognize that tiered full-graph interconnects with different numbers of levels are also possible without departing from the spirit and scope of the present invention. In particular, the number of tiers in the TTFG interconnect architecture could be as few as one or as many as may be implemented. Thus, any number of buses may be used with the mechanisms of the illustrative embodiments. That is, the illustrative embodiments are not limited to requiring Z-buses and D-buses. The example shown in FIGS. 4A and 4B is only for illustrative purposes and is not intended to state or imply any limitation with regard to the numbers or arrangement of elements other than the general organization of processors into supernodes, and supernodes into a TTFG interconnect architecture network.

Taking the above described connection of processor chips 402 and SNs 408 as exemplary of one illustrative embodiment, the interconnection of links between processor chips 402 and SNs 408 may be reduced by at least fifty percent when compared to externally connected networks, i.e. networks in which processors communicate with an external switch in order to communicate with each other, while still providing the same bisection of bandwidth for all communication. Bisection of bandwidth is defined as the minimum bi-directional bandwidths obtained when the two-tier full-graph interconnect is bisected in every way possible while maintaining an equal number of nodes in each half. That is, known systems, such as systems that use fat-tree switches, which are external to the processor chip, only provide one connection from a processor chip to the fat-tree switch. Therefore, the communication is limited to the bandwidth of that one connection. In the illustrative embodiments, one of processor chips 402 may use the entire bisection of bandwidth provided through integrated switch/router (ISR) 416, which may be ISR 340 of FIG. 3, for example, to either:
communicate to another processor chip 402 on a same SNs 408 where processor chip 402 resides via Z-buses 406, or
communicate to another processor chip 402 in another SN 408 in another one of SNs 408 via D-buses 414.

That is, if a communicating parallel “job” being run by one of processor chips 402 hits a communication point, i.e. a point in the processing of a job where communication with another processor chip 402 is required, then processor chip 402 may use any of the processor chip's Z-buses 406 or D-buses 414 to communicate with another processor as long as the bus is not currently occupied with transferring other data. Thus, by moving the switching capabilities inside the processor chip itself instead of using switches external to the processor chip, the communication bandwidth provided by the two-tier full-graph interconnect architecture of data communication topology 400 is made relatively large compared to known systems, such as the fat-tree switch based network which again, only provides a single communication link between the processor and an external switch complex.

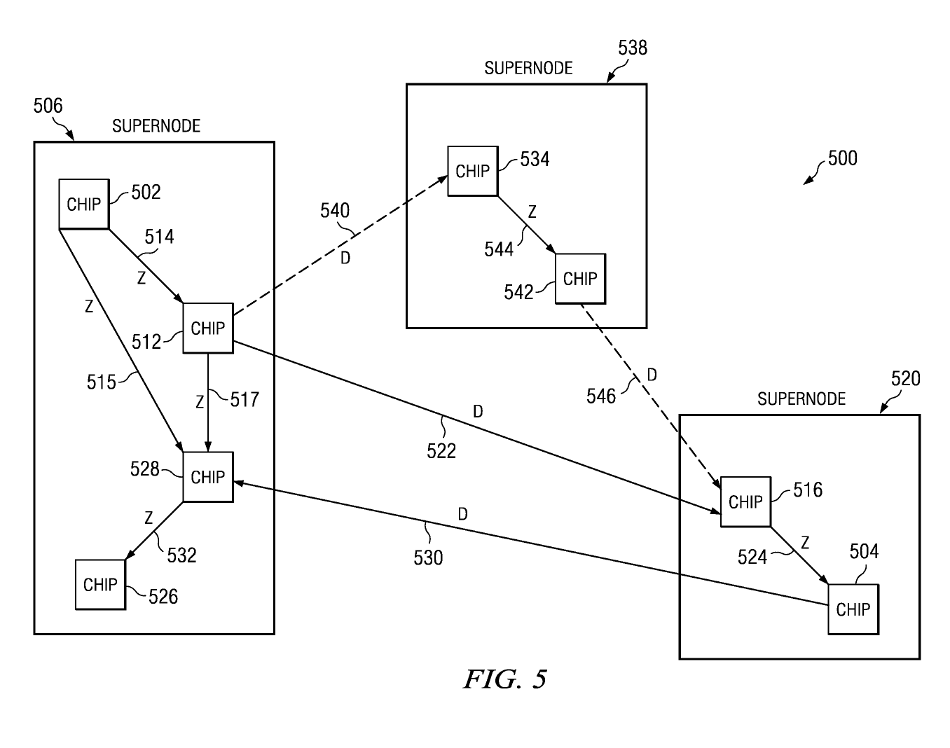

FIG. 5 depicts an example of direct and indirect transmissions of information using a two-tier full-graph interconnect architecture in accordance with one illustrative embodiment. It should be appreciated that the term “direct” as it is used herein refers to using the fewest number of buses, whether they be Z-buses or D-buses, to communicate data from a source element (e.g., processor chip or supernode), to a destination or target element (e.g., processor chip or supernode). Thus, for example, two processor chips in the same supernode have a direct connection using a single Z-bus. Two supernodes have a direct connection using a single D-bus. The term “indirect” as it is used herein refers to using a plurality of buses, i.e. any combination of Z-buses and/or D-buses, to communicate data from a source element to a destination or target element over a path that is longer than the shortest path between the source and destination elements.

FIG. 5 illustrates a direct connection with respect to the D-bus 522 and an indirect connection with regard to D-buses 540 and 546. As shown in the example depicted in FIG. 5, in two-tier full-graph (TTFG) interconnect architecture 500, processor chip 502 transmits information, e.g., a data packet or the like, to processor chip 504 via Z-buses and D-buses. For simplicity in illustrating direct and indirect transmissions of information, supernode 506 is shown to include only four processor chips, while supernodes 538 and 520 are shown to include only two processor chips each, while the above illustrative embodiments show that a supernode may include numerous processor chips.

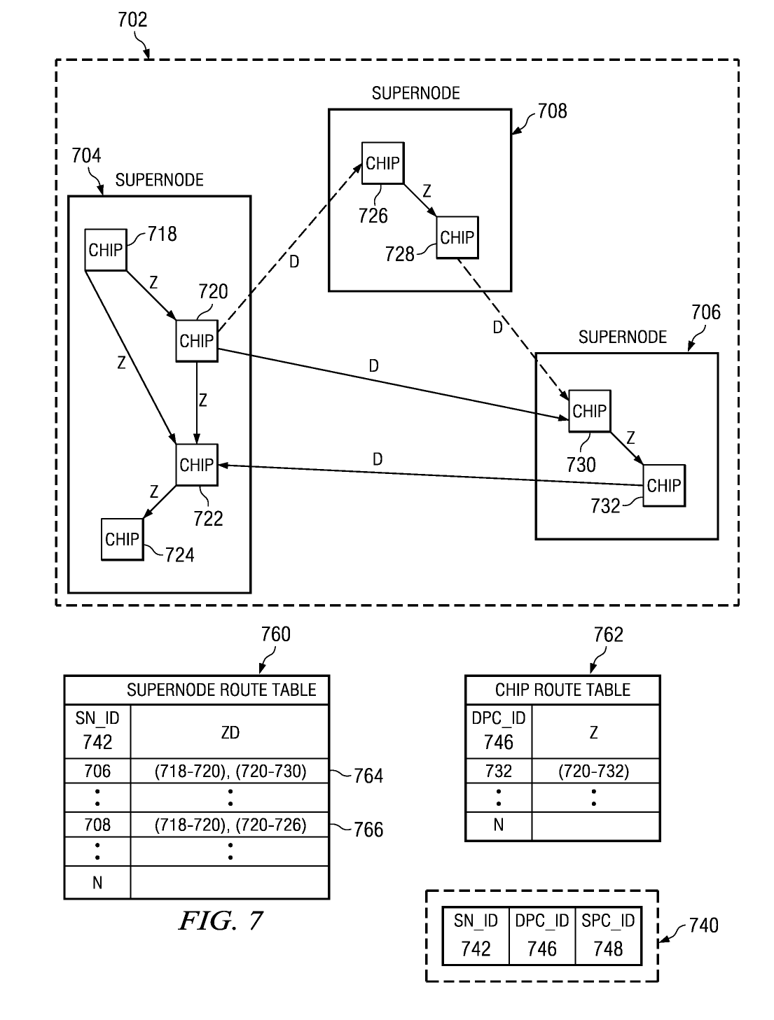

As an example of a direct transmission of information between processor chips in different supernodes, processor chip 502 initializes the transmission of information to processor chip 504 by first transmitting the information on Z-bus 514 to processor chip 512. Then, processor chip 512 transmits the information to processor chip 516 in SN 520 via D-bus 522. Once the information arrives in processor chip 516, processor chip 516 transmits the information to processor chip 504 via Z-bus 524. Again, each of the processor chips, in the path the information follows from processor chip 502 to processor chip 504, determines its own routing using routing table topology that is specific to each processor chip. This routing table topology will be described in greater detail hereafter with reference to FIG. 7.

As an example of a direct transmission of information between processor chips in the same supernode, processor chip 502 transmits information to processor chip 528 by utilizing Z-bus 515. As an example of an indirect transmission of information between processor chips in the same supernode, processor chip 502 initializes the transmission of information to processor chip 528 by first transmitting the information on Z-bus 514 to processor chip 512. Then processor chip 512 transmits the information to processor chip 528 by utilizing the Z-bus 517.

As an example of an indirect transmission of information from processor chip 502 to processor chip 504, with regard to the D-buses, processor chip 502 generally transmits the information to processor chip 512 in the same manner as described above with respect to the direct transmission of information between processor chips in different supernodes. However, if D-bus 522 is not available for transmission of data to processor chip 516, or if the full outgoing interconnect bandwidth from SN 506 were desired to be utilized in the transmission, then processor chip 512 may transmit the information to processor chip 534 in SN 538, which is an intermediary supernode, via D-bus 540. Once the information arrives in processor chip 534, processor chip 534 transmits the information to processor chip 542 via Z-bus 544. Processor chip 542 then transmits the information to processor chip 516 via D-bus 546. Once the information arrives in processor chip 516, processor chip 516 transmits the information to processor chip 504 via Z-bus 524 in the same manner as described above with respect to the direct transmission of information. Again, each of the processor chips, in the path the information follows from processor chip 502 to processor chip 504, determines its own routing using routing table topology that is specific to each processor chip. This indirect routing table topology will be described in greater detail hereafter with reference to FIG. 15.

Thus, the exemplary direct and indirect transmission paths provide the most non-limiting routing of information from processor chip 502 to processor chip 504. What is meant by “non-limiting” is that the combination of the direct and indirect transmission paths provide the resources to provide full bandwidth connections for the transmission of data during substantially all times since any degradation of the transmission ability of one path will cause the data to be routed through one of a plurality of other direct or indirect transmission paths to the same destination or target processor chip. Thus, the ability to transmit data is not limited when paths become available due to the alternative paths provided through the use of direct and indirect transmission paths in accordance with the illustrative embodiments.

That is, while there may be only one minimal path available to transmit information from processor chip 502 to processor chip 504, restricting the communication to such a path may constrain the bandwidth available for the two chips to communicate. Indirect paths may be longer than direct paths, but permit any two communicating chips to utilize many more of the paths that exist between them. As the degree of indirectness increases, the extra links provide diminishing returns in terms of useable bandwidth. Thus, while the direct route from processor chip 502 to processor chip 504 shown in FIG. 5 uses only 3 links, the indirect route from processor chip 502 to processor chip 504 shown in FIG. 5 uses 5 links. Furthermore, it will be understood by one skilled in the art that when processor chip 502 has more than one outgoing Z-bus, it could use those to form an indirect route. Similarly, when processor chip 502 has more than one outgoing D-bus, it could use those to form indirect routes.

Thus, through the two-tier full-graph interconnect architecture of the illustrative embodiments, multiple direct communication pathways between processors are provided such that the full bandwidth of connections between processors may be made available for communication. Moreover, a large number of redundant, albeit indirect, pathways may be provided between processors for use in the case that a direct pathway is not available, or the full bandwidth of the direct pathway is not available, for communication between the processors.

By organizing the processor chips and supernodes in a two-tier full-graph arrangement, such redundancy of pathways is made possible. The ability to utilize the various communication pathways between processors is made possible by the integrated switch/router (ISR) of the processor chips which selects a communication link over which information is to be transmitted out of the processor chip. Each of these ISRs, as will be described in greater detail hereafter, stores one or more routing tables that are used to select between communication links based on previous pathways taken by the information to be communicated, current availability of pathways, available bandwidth, and the like. The switching performed by the ISRs of the processor chips of a supernode is performed in a fully non-blocking manner. By “fully non-blocking” what is meant is that it never leaves any potential switching bandwidth unused if possible. If an output link has available capacity and there is a packet waiting on an input link to go to it, the ISR will route the packet if possible. In this manner, potentially as many packets as there are output links get routed from the input links. That is, whenever an output link can accept a packet, the switch will strive to route a waiting packet on an input link to that output link, if that is where the packet needs to be routed. However, there may be many qualifiers for how a switch operates that may limit the amount of usable bandwidth.

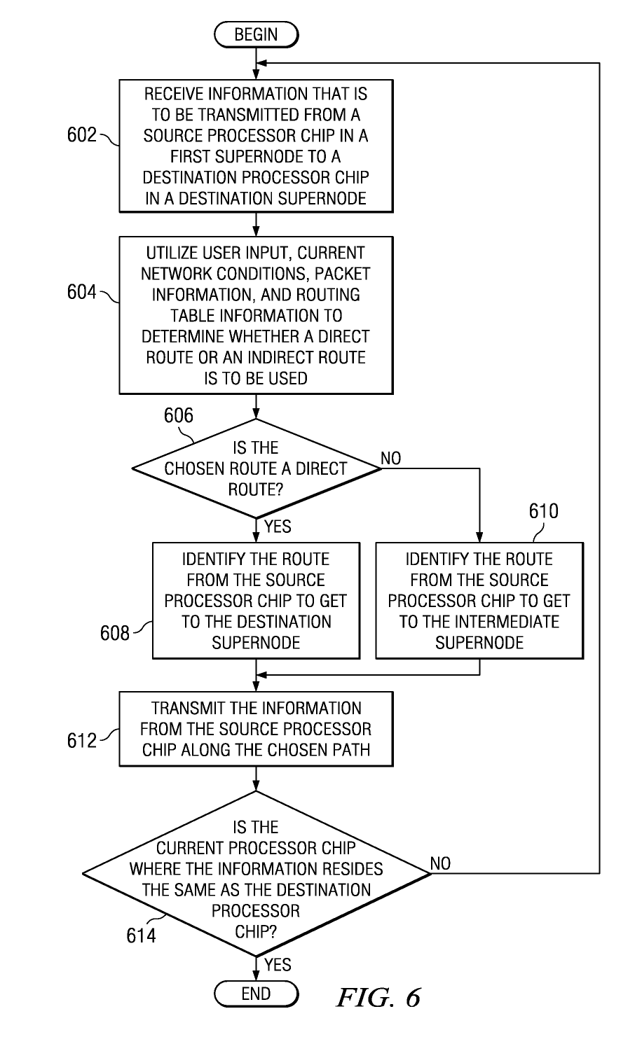

FIG. 6 depicts a flow diagram of the operation performed in the direct and indirect transmissions of information using a two-tier full-graph interconnect architecture in accordance with one illustrative embodiment. FIGS. 6, 8, and 9 are flowcharts that illustrate the exemplary operations according to the illustrative embodiments. It will be understood that each block of the flowchart illustrations, and combinations of blocks in the flowchart illustrations, may be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

Furthermore, the flowcharts are provided to demonstrate the operations performed within the illustrative embodiments. The flowcharts are not meant to state or imply limitations with regard to the specific operations or, more particularly, the order of the operations. The operations of the flowcharts may be modified to suit a particular implementation without departing from the spirit and scope of the present invention.

With regard to FIG. 6, the operation begins when a source processor chip, such as processor chip 502 of FIG. 5, in a first supernode receives information, e.g., a data packet or the like, that is to be transmitted to a destination processor chip via buses, such as Z-buses and D-buses (step 602). The integrated switch/router (ISR) that is associated with the source processor chip analyzes user input, current network conditions, packet information, routing tables, or the like, to determine whether to use a direct pathway or an indirect pathway from the source processor chip to the destination processor chip through the two-tier full-graph architecture network (step 604). The ISR next checks if a direct path is to be used or if an indirect path is to be used (step 606).

Here, the terms “direct” and “indirect” may be with regard to any one of the buses, Z-bus or D-bus. Thus, if the source and destination processor chips are within the same supernode, a direct path between the processor chips may be made by way of a Z-bus. Similarly, if the source and destination processor chips are in separate supernodes, a direct path using a single D-bus may be used (which may still involve up to one Z-bus to get the data out of the source supernode and within the destination supernode to get the data to the destination processor chip). However, if the source and destination processor chips are within the same supernode, an indirect path may be utilized that uses a plurality of Z-paths. If the source and destination processor chips are in separate supernodes, an indirect path may be utilized that uses a plurality of D-paths (where such a path is indirect because it uses more buses than required in the shortest path between the source and the destination).

If at step 606 a direct pathway is determined to have been chosen to transmit from the source processor chip to the destination processor chip, the ISR identifies the initial component of the direct path to use for transmission of the information from the source processor chip to the destination supernode (step 608). If at step 606 an indirect pathway is determined to have been chosen to transmit from the source processor chip to the destination processor chip, the ISR identifies the initial component of the indirect path to use for transmission of the information from the source processor chip to an intermediate supernode (step 610). From step 608 or 610, the ISR initiates transmission of the information from the source processor chip along the identified direct or indirect pathway (step 612). After the ISR of the source processor chip transmits the data to the last processor chip along the identified path, the ISR of the processor chip where the information resides determines if it is the destination processor chip (step 614). If at step 614 the ISR determines that the processor chip where the information resides is not the destination processor chip, the operation returns to step 602 and may be repeated as necessary to move the information from the point to which it has been transmitted, to the destination processor chip.

If at step 614, the processor chip where the information resides is the destination processor chip, the operation terminates. An example of a direct transmission of information and an indirect transmission of information is shown in FIG. 5 above. Thus, through the two-tier full-graph interconnect architecture of the illustrative embodiments, information may be transmitted from a one processor chip to another processor chip using multiple direct and indirect communication pathways between processors.

FIG. 7 depicts an exemplary method of ISRs utilizing routing information to route data through a two-tier full-graph interconnect architecture network in accordance with one illustrative embodiment. In the example, routing of information through a two-tier full-graph (TTFG) interconnect architecture, such as TTFG interconnect architecture 500 of FIG. 5, may be performed by each ISR of each processor chip on a hop-by-hop basis as the data is transmitted from one processor chip to the next in a selected communication path from a source processor chip to a target recipient processor chip. As shown in FIG. 7, and similar to the depiction in FIG. 5, TTFG interconnect architecture 702 includes supernodes (SNs) 704, 706, and 708, and processor chips (PCs) 718-732. In order to route information from PC 718 to PC 732 in TTFG interconnect architecture 702, the ISRs may use a two-tier routing table data structure topology. While this example uses a two-tier routing table data structure topology, the illustrative embodiments recognize that other numbers of table data structures may be used to route information from one processor chip to another processor chip in TTFG interconnect architecture 702 without departing from the spirit and scope of the present invention. The number of table data structures may be dependent upon the particular number of tiers in the architecture.

The two-tier routing data structure topology of the illustrative embodiments includes a supernode (SN) routing table data structure which is used to route data out of a source supernode to a destination supernode and a chip routing table data structure which is used to route data from one chip to another within the same supernode. It should be appreciated that a version of the two-tier data structure may be maintained by each ISR of each processor chip in the TTFG interconnect architecture network with each copy of the two-tier data structure being specific to that particular processor chip's position within the TTFG interconnect architecture network. Alternatively, the two-tier data structure may be a single data structure that is maintained in a centralized manner and which is accessible by each of the ISRs when performing routing. In this latter case, it may be necessary to index entries in the centralized two-tier routing data structure by a processor chip identifier, such as a SPC_ID as discussed hereafter, in order to access an appropriate set of entries for the particular processor chip.

In the example shown in FIG. 7, a host fabric interface (HFI) (not shown) of a source processor chip, such as HFI 338 in FIG. 3, provides an address 740 of where the information is to be transmitted, which includes supernode identifier (SN_ID) 742, destination processor chip identifier (DPC_ID) 746, and source processor chip identifier (SPC_ID) 748. The transmission of information may originate from software executing on a core of the source processor chip. The executing software identifies the request for transmission of information that needs to be transmitted to a task executing on a particular chip in the system. The executing software identifies this information when a set of tasks that constitute a communicating parallel “job” are spawned on the system, as each task provides information that lets the software and eventually HFI 338 determine on which chip every other task is executing. The entire system follows a numbering scheme that is predetermined, such as being defined in hardware. For example, given a chip number X ranging from 0 to 65535, there is a predetermined rule to determine the supernode and the specific chip within the supernode that X corresponds to. Therefore, once software informs HFI 338 to transmit the information to chip number 24356, HFI 338 decomposes chip 24356 into the correct supernode, and chip-within-supernode using a rule. In a 65536 chip system where 128 processor chips form a supernode and 512 supernodes form the system), the rule may be as simple as: SN=floor (X/128); and CHIP-WITHIN-SN=X modulo 128. Address 740 may be provided in the header information of the data that is to be transmitted so that subsequent ISRs along the path from the source processor chip to the destination processor chip may utilize the address in determining how to route the data. For example, portions of address 740 may be used to compare to routing table data structures maintained in each of the ISRs to determine the next link over which data is to be transmitted.

It should be appreciated that SPC_ID 748 is not needed for routing the data to the destination processor chip, as illustrated hereafter, since each of the processor chip's routing table data structures are indexed by destination identifiers and thus, all entries would have the same SPC_ID 748 for the particular processor chip with which the table data structure is associated. However, in the case of a centralized two-tier routing table data structure, SPC_ID 748 may be necessary to identify the particular subset of entries used for a particular source processor chip. In either case, whether SPC_ID 748 is used for routing or not, SPC_ID 748 may be included in the address in order for the destination processor chip to know where responses should be directed when or after processing the received data from the source processor chip.

In routing data from a source processor chip to a destination processor chip, each ISR of each processor chip that receives the data for transmission uses a portion of address 740 to access its own, or a centralized, two-tier routing data structure to identify a path for the data to take. In performing such routing, the ISR of the processor chip first looks to SN_ID 742 of the destination address to determine if SN_ID 742 matches the SN_ID of the current supernode in which the processor chip is present. The ISR receives the unique SN_ID of its associated supernode at startup time from the software executing on the processor chip associated with the ISR, so that the ISR may use the SN_ID for routing purposes. If SN_ID 742 matches the SN_ID of the supernode of the processor chip that is processing the data, then the destination processor chip is within the current supernode, and so the ISR checks DPC_ID 746 to determine if DPC_ID 746 matches the processor chip identifier of the present processor chip processing the data. If there is a match, the ISR supplies the data through the HFI associated with the processor chip DPC_ID, which processes the data.

If at any of these checks, the respective ID does not match the corresponding ID associated with the present processor chip that is processing the data, then an appropriate lookup in a tier of the two-tier routing table data structure is performed. Thus, for example, if SN_ID 742 in address 740 does not match the SN_ID of the present processor chip, then a lookup is performed in supernode routing table data structure 760 based on SN_ID 742 in address 740 to identify a pathway for routing the data out of the present supernode and to the destination supernode, such as via a pathway comprising a particular set of ZD-bus communication links.

If SN_ID 742 matches the SN_ID of the present processor chip, but DPC_ID 746 does not match the processor chip identifier of the present processor chip, then the destination processor chip is a different processor chip with in the same supernode. As a result, a lookup operation is performed using processor chip routing table data structure 762 based on DPC_ID 746 in address 740. The result is a Z-bus link over which the data should be transmitted to reach the destination processor chip.

FIG. 7 illustrates exemplary supernode (SN) routing table data structure 760 and processor chip routing table data structure 762 for the portions of the path where these particular data structures are utilized to perform a lookup operation for routing data to a destination processor chip. Thus, for example, SN routing table data structure 760 is associated with processor chip 718 and processor chip routing table data structure 762 is associated with processor chip 730. It should be appreciated that in one illustrative embodiment, each of the ISRs of these processor chips would have a copy of the two types of routing table data structures, specific to the processor chip's location in the TTFG interconnect architecture network, however, not all of the processor chips will require a lookup operation in each of these data structures in order to forward the data along the path from source processor chip 718 to destination processor chip 732.

As with the example in FIGS. 4A and 4B, in a TTFG interconnect architecture that contains a large number of buses connecting supernodes, e.g., 512 D-buses, supernode (SN) routing table data structures 760 would include a large number of entries, e.g., 512 entries for the example of FIGS. 4A and 4B. The number of options for the transmission of information from, for example, processor chip 718 to SN 706 depends on the number of connections between processor chip 718 to SN 706. Thus, for a particular SN_ID 742 in SN routing table data structure 760, there may be multiple entries specifying different direct paths for reaching supernode 706 corresponding to SN_ID 742. Various types of logic may be used to determine which of the entries to use in routing data to supernode 706. When there are multiple direct paths from supernode 704 to supernode 706, logic may take into account factors when selecting a particular entry/route from SN routing table data structure 760, such as the ECC and CRC error rate information obtained as previously described, traffic levels, etc. Any suitable selection criteria may be used to select which entry in SN routing table data structure 760 is to be used with a particular SN_ID 742.

In a fully provisioned TTFG interconnect architecture system, there will be one path for the direct transmission of information from a processor chip to a specific SN. With SN_ID 742, the ISR may select the direct route or any indirect route to transmit the information to the desired location using SN routing table data structure 760. The ISR may use any number of ways to choose between the available routes, such as random selection, adaptive real-time selection, round-robin selection, or the ISR may use a route that is specified within the initial request to route the information. The particular mechanism used for selecting a route may be specified in logic provided as hardware, software, or any combination of hardware and software used to implement the ISR.

In this example, the ISR of processor chip 718 selects route 764 from supernode route table data structure 760, which will route the information from processor chip 718 to processor chip 730. In routing the information from processor chip 718 to processor chip 730, the ISR of processor chip 718 may append the selected supernode path information to the data packets being transmitted to thereby identify the path that the data is to take through supernode 704. Each subsequent processor chip in supernode 704 may see that SN_ID 742 for the destination processor chip does not match its own SN_ID and that the supernode path field of the header information is populated with a selected path. As a result, the processor chips know that the data is being routed out of current supernode 704 and may look to a supernode counter maintained in the header information to determine the current hop within supernode 704.

For example, in the depicted supernode 704, there are 2 hops from processor chip 718 to processor chip 730. The supernode path information similarly has 2 hops represented as ZD values. The supernode counter may be incremented with each hop such that processor chip 720 knows based on the supernode counter value that it is the second hop along the supernode path specified in the header information. As a result, it can retrieve the next hop from the supernode path information in the header and forward the data along this next link in the path. In this way, once source processor chip 718 sets the supernode path information in the header, the other processor chips within the same supernode need not perform a SN routing table data structure 760 lookup operation. This not only increases the speed at which the data is routed out of source supernode 704, but also causes the routing intentions of the source processor chip 718 to be respected by intermediate ISRs.

When the data packets reach processor chip 730 after being routed out of supernode 704 along the D-bus link to processor chip 730, the ISR of processor chip 730 performs a comparison of SN_ID 742 in address 740 with its own SN_ID and, in this example, determines that they match. As a result, the ISR of the processor chip 730 does not look to the supernode path information but instead looks to a processor chip path information field to determine if a processor chip path has been previously selected for use in routing data through the supernode 706 in which processor chip 730 resides.

In the present case, processor chip 730 is the first processor in the supernode 706 to receive the data and thus, a processor chip path has not already been selected. When processor chip 730 receives the information/data packets, the ISR of the processor chip 730 checks SN_ID 742 of address 740 and determines that SN_ID 742 matches its own associated SN_ID. The ISR of processor chip 730 then DPC_ID 746 of address 740 against its own processor chip identifier and determines that the two do not match. As a result, the ISR of processor chip 730 performs a lookup operation in processor chip routing table data structure 762 using DPC_ID 746. The resulting Z path is then used by the ISR to route the information/data packets to the destination processor chip 732.

Processor chip routing table data structure 762 includes routing for every processor chip to every other processor chip within the same supernode. As with supernode route table data structure 760, processor chip routing table data structure 762 may also be generic, in that the position of each processor chip to every other processor chip within a supernode is known by the ISRs. Thus, processor chip routing table data structure 762 may be generically used within each supernode based on the position of the processor chips, as opposed to specific identifiers as used in this example.

As with the example in FIGS. 4A and 4B, in a TTFG interconnect architecture that contains 7 Z-buses, processor chip routing table data structure 762 would include 8 entries. Thus, processor chip routing table data structure 762 would include only one option for the transmission of information from processor chip 730 to processor chip 732. Alternatively, in lieu of the single direct Z path, the ISR may choose to use indirect routing at the Z level. Of course, the ISR will do so only if the number of virtual channels are sufficient to avoid the possibility of deadlock. In certain circumstances, a direct path from one supernode to another supernode may not be available. This may be because all direct D-buses are busy, incapacitated, or the like, making it necessary for an ISR to determine an indirect path to get the information/data packets from SN 704 to SN 706. For instance, the ISR of processor chip 718 could detect that a direct path is temporarily busy because the particular virtual channel that it must use to communicate on the direct route has no free buffers into which data can be inserted. Alternatively, the ISR of processor chip 718 may also choose to send information over indirect paths so as to increase the bandwidth available for communication between any two end points. As with the above example, the HFI of the source processor provides the address of where the information is to be transmitted, which includes supernode identifier (SN_ID) 742, destination processor chip identifier (DPC_ID) 746, and source processor chip identifier (SPC_ID) 748. Again, the ISR uses the SN_ID 742 to reference the supernode routing table data structure 760 to determine a route that will get the information from processor chip 718 to supernode (SN) 706.

However, in this instance the ISR may determine that no direct routes are available, or even if available, should be used (due to, for example, traffic reasons or the like). In this instance, the ISR would determine if a path through another supernode, such as supernode 708, is available. For example, the ISR of processor chip 718 may select route 766 from supernode routing table data structure 760, which will route the information from processor chips 718 and 720 to processor chip 726. The routing through supernode 704 to processor chip 726 in supernode 708 may be performed in a similar manner as described previously with regard to the direct route to supernode 706. When the information/data packets are received in processor chip 726, a similar operation is performed where the ISR of processor chip 726 selects a path from its own supernode routing table data structure to route the information/data from processor chip 726 to processor chip 730. The routing is then performed in a similar way as previously described between processor chip 718 and processor chip 730.

The choice to use a direct route or indirect route may be software determined, hardware determined, or provided by an administrator. Additionally, the user may provide the exact route or may merely specify direct or indirect, and the ISR of the processor chip would select from the direct or indirect routes based on such a user defined designation. It should be appreciated that it is desirable to minimize the number of times an indirect route is used to arrive at a destination processor chip, or its length, so as to minimize latency due to indirect routing. Thus, there may be an identifier added to header information of the data packets identifying whether an indirect path has been already used in routing the data packets to their destination processor chip. For example, the ISR of the originating processor chip 718 may set this identifier in response to the ISR selecting an indirect routing option. Thereafter, when an ISR of a processor chip is determining whether to use a direct or indirect route to transmit data to another supernode, the setting of this field in the header information may cause the ISR to only consider direct routes.

Alternatively, this field may constitute a counter which is incremented each time an ISR in a supernode selects an indirect route for transmitting the data out of the supernode. This counter may be compared to a threshold that limits the number of indirect routes that may be taken to arrive at the destination processor chip, so as to avoid exhausting the number of virtual channels that have been pre-allocated on the path.

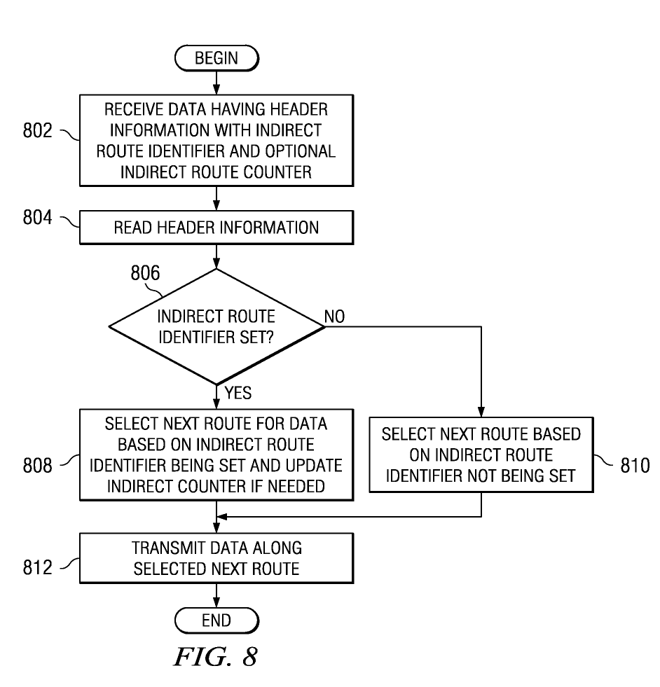

FIG. 8 is a flowchart outlining an exemplary operation for selecting a route based on whether or not the data has been previously routed through an indirect route to the current processor, in accordance with one illustrative embodiment. The operation outlined in FIG. 8 may be performed, for example, within an ISR of a processor chip, either using hardware, software, or any combination of hardware and software within the ISR. It should be noted that in the following discussion of FIG. 8, “indirect” and “direct” are used in regard to the D-buses, i.e. buses between supernodes.

As shown in FIG. 8, the operation starts with receiving data having header information with an indirect route identifier and an optional indirect route counter (step 802). The header information is read (step 804) and a determination is made as to whether the indirect route identifier is set (step 806). As mentioned above, this identifier may in fact be a counter in which case it can be determined in step 806 whether the counter has a value greater than 0 indicating that the data has been routed through at least one indirect route.

If the indirect route identifier is set, then a next route for the data is selected based on the indirect route identifier being set and indirect route counter is incremented if used (step 808). If the indirect route identifier is not set, then the next route for the data is selected based on the indirect route being not set (step 810). The data is then transmitted along the next route (step 812) and the operation terminates. It should be appreciated that the above operation may be performed at each processor chip along the pathway to the destination processor chip, or at least in the first processor chip encountered in each supernode along the pathway.

In step 808 certain candidate routes or pathways may be identified by the ISR for transmitting the data to the destination processor chip which may include both direct and indirect routes. Certain ones of these routes or pathways may be excluded from consideration based on the indirect route identifier being set. For example, the logic in the ISR may specify that if the data has already been routed through an indirect route or pathway, then only direct routes or pathways may be selected for further forwarding of the data to its destination processor chip. Alternatively, if an indirect route counter is utilized, the logic may determine if a threshold number of indirect routes have been utilized, such as by comparing the counter value to a predetermined threshold, and if so, only direct routes may be selected for further forwarding of the data to its destination processor chip. If the counter value does not meet or exceed that threshold, then either direct or indirect routes may be selected. In another embodiment that utilizes an indirect route counter, the source processor chip may set the counter to be a specific value that is then decremented by intermediate ISRs every time an indirect route is selected. When the counter reaches zero, all remaining intermediate ISRs would be constrained to only use direct routes from then on.

Thus, the benefits of using a two-tier routing table data structure topology is that only one 512 entry supernode route table and one 8 entry chip table lookup operation are required to route information across a TTFG interconnect architecture. Although the illustrated table data structures are specific to the depicted example, the processor chip routing table data structure may be generic to every group of processor chips in a supernode. The use of the two-tier routing table data structure topology is an improvement over known systems that use only one table and thus would have to have a routing table data structure that consists of 65,535 entries to route information for a TTFG interconnect architecture, such as the TTFG interconnect architecture shown in FIGS. 4A and 4B, and which would have to be searched at each hop along the path from a source processor chip to a destination processor chip. Needless to say, in a TTFG interconnect architecture that consists of different levels, routing will be accomplished through correspondingly different numbers of tables. Furthermore, in a TTFG interconnect architecture that consists of X processor chips per supernode and Y supernodes per system, the supernode route table would have Y entries, and the chip table would have X entries.

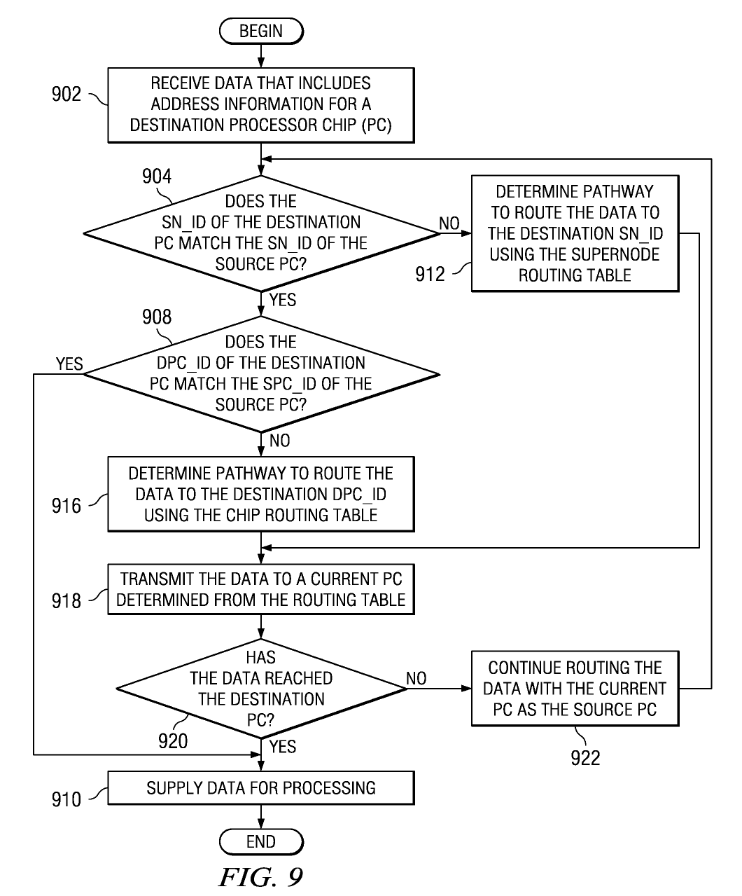

FIG. 9 depicts a flow diagram of the operation performed to route data through a two-tier full-graph interconnect architecture network in accordance with one illustrative embodiment. In the flow diagram the routing of information through a two-tier full-graph (TTFG) interconnect architecture may be performed by each ISR of each processor chip on a hop-by-hop basis as the data is transmitted from one processor chip to the next in a selected communication path from a source processor chip to a target recipient processor chip. As the operation begins, an ISR receives data that includes address information for a destination processor chip (PC) from a host fabric interface (HFI), such as HFI 338 in FIG. 3 (step 902). The data provided by the HFI includes an address of where the information is to be transmitted, which includes a supernode identifier (SN_ID), a destination processor chip identifier (DPC_ID), and a source processor chip identifier (SPC_ID). The ISR of the PC first looks to the SN_ID of the destination address to determine if the SN_ID matches the SN_ID of the current supernode in which the source processor chip is present (step 904). If at step 904 the SN_ID matches the SN_ID of the supernode of the source processor chip that is processing the data, then the ISR of that processor chip checks the DPC_ID to determine if the DPC_ID matches the processor chip identifier of the source processor chip processing the data (step 908). If at step 908 there is a match, then the source processor chip processes the data (step 910), with the operation ending thereafter.

If at step 904 the SN_ID fails to match the SN_ID of the supernode of the source processor chip that is processing the data, then the ISR references a supernode routing table to determine a pathway to route the data out of the present supernode to the destination supernode (step 912). Likewise, if at step 908 the DPC_ID fails to match the SPC_ID of the source processor chip, then the ISR reference a processor chip routing table data structure to determine a pathway to route the data from the source processor chip to the destination processor chip (step 916).

From steps 912, or 916, once the pathway to route the data from the source processor chip to the respective supernode, or processor chip is determined, the ISR transmits the data to a current processor chip along the identified pathway (step 918). Once the ISR completes the transmission, the ISR where the data now resides determines if the data has reached the destination processor chip by comparing the current processor chip's identifier to the DPC_ID in the address of the data (step 920). If at step 920 the data has not reached the destination processor chip, then the ISR of the current processor chip where the data resides, continues the routing of the data with the current processor chip's identifier used as the SPC_ID (step 922), with the operation proceeding to step 904 thereafter. If at step 920 the data has reached the destination processor chip, then the operation proceeds to step 910.

Thus, using a two-tiered routing table data structure topology that comprises only one 512 entry supernode route table and one 128-entry chip table lookup to route information across a TTFG interconnect architecture improves over known systems that use only one table that consists of 65,535 entries to route information.

Thus, the illustrative embodiments provide a highly-configurable, scalable system that integrates computing, storage, networking, and software. The illustrative embodiments provide for a two-tier full-graph interconnect architecture that improves communication performance for parallel or distributed programs and improves the productivity of the programmer and system. With such an architecture, and the additional mechanisms of the illustrative embodiments described herein, a two-tier full-graph interconnect architecture is provided in which maximum bandwidth is provided to each of the processors or nodes such that enhanced performance of parallel or distributed programs is achieved.

It should be appreciated that the illustrative embodiments may take the form of a specialized hardware embodiment, a software embodiment that is executed on a computer system having general processing hardware, or an embodiment containing both specialized hardware and software elements that are executed on a computer system having general processing hardware. In one exemplary embodiment, the mechanisms of the illustrative embodiments are implemented in a software product, which may include but is not limited to firmware, resident software, microcode, etc.

Furthermore, the illustrative embodiments may take the form of a computer program product accessible from a computer-usable or computer-recordable medium providing program code recorded thereon for use by or in connection with a computer or any instruction execution system. For the purposes of this description, a computer-usable or computer-recordable medium can be any apparatus that can contain, store, communicate, propagate, or transport the program for use by or in connection with the instruction execution system, apparatus, or device.

The medium may be an electronic, magnetic, optical, electromagnetic, or semiconductor system, apparatus, or device. Examples of a computer-recordable medium include a semiconductor or solid state memory, magnetic tape, a removable computer diskette, a random access memory (RAM), a read-only memory (ROM), a rigid magnetic disk, and an optical disk. Current examples of optical disks include compact disk-read-only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A data processing system, comprising:
a plurality of processors coupled to one another to create a plurality of supernodes; and
the plurality of supernodes coupled together, wherein data is transmitted from one processor to another based on an addressing scheme specifying at least a supernode identifier and a processor chip identifier associated with a target processor to which the data is to be transmitted.

2. The system of claim 1, wherein a subset of processors of the plurality of processors is associated with each supernode of the plurality of supernodes, and wherein each processor within the supernode is directly coupled to each other processor within the supernode.

3. The system of claim 1, wherein each supernode within a subset of the plurality of supernodes is directly coupled to each other supernode within the subset of the plurality of supernodes.

4. The system of claim 2, wherein the subset of processors comprises at least eight processors.

5. The system of claim 3, wherein the subset of the plurality of supernodes comprises at least five hundred and twelve supernodes.

6. The system of claim 1, wherein:
a subset of processors of the plurality of processors is associated with each supernode of the plurality of supernodes, and wherein each processor within the supernode is directly coupled to each other processor within the supernode; and
each supernode within a subset of the plurality of supernodes is directly coupled to each other supernode within the subset of supernodes.

7. The system of claim 6, wherein:
the subset of processors are coupled to each other by a set of first buses;
the subset of supernodes are coupled to each other by a set of second buses; and
data is routed from one processor in a first supernode to another processor in a second supernode using at least one routing table data structure that specifies at least one first bus and at least one second bus over which the data is to be transmitted.

8. The system of claim 7, wherein at least one of the set of first buses and the set of second buses are cache coherent buses.

9. The system of claim 7, wherein at least one of the set of first buses and the set of second buses are non-cache coherent buses.

10. The system of claim 7, wherein the set of first buses are cache coherent and wherein the set of second buses are non-cache coherent buses.

11. The system of claim 1, wherein each processor in the plurality of processors of a supernode comprises at least four communication links for coupling the processor to at least four other supernodes in the plurality of supernodes.

12. The system of claim 1, wherein each supernode of the plurality of supernodes comprises at least five hundred and eleven communication links for coupling the supernode to at least five hundred and eleven other supernodes in the plurality of supernodes.

13. The system of claim 1, wherein each processor of the plurality of processors has an integrated switch, and wherein the integrated switch in the processor implements the addressing scheme to route data from that processor to at least one other processor in the plurality of processors.

14. The system of claim 13, wherein the integrated switch in each processor of the plurality of processors utilizes one or more routing table data structures that specify pathways from the processor to other processors in the data processing system based on the supernode identifier and the processor chip identifier.

15. The system of claim 1, wherein each processor in the supernode is directly coupled to four other processors within different supernodes, the four other processors each being in separate other supernodes.

16. The system of claim 1, wherein each processor has a plurality of cores.

17. The system of claim 16, wherein the plurality of cores are homogeneous.

18. The system of claim 16, wherein the plurality of cores are heterogeneous.

19. The system of claim 1, wherein the data processing system utilizes a low-cost two-tier full-graph interconnect architecture.

20. A method, in a data processing system, comprising:
coupling a plurality of processors to one another to create a plurality of supernodes; and
coupling the plurality of supernodes together, wherein data is transmitted from one processor to another processor based on an addressing scheme specifying at least a supernode identifier and a processor chip identifier associated with a target processor to which the data is to be transmitted.
